(19) United States
(12) Patent Application Publication
(10) Pub. No.: US 2012/0107456 A1
(43) Pub. Date: May 3, 2012

(54) Encrusted Cheese Scoop and Method

(76) Inventors: Gerard J. Hogan, Kohler, WI (US); Joseph J. Lisowe, Plymouth, WI (US); Bridget Bartel, Chilton, WI (US); Kenneth Lightfield, Sherwood, WI (US)

(21) Appl. No.: 12/913,477

(22) Filed: Oct. 27, 2010

(51) Int. Cl. A23C 19/00; A23P 1/12; A23P 1/08

(52) U.S. Cl. 426/92; 426/94; 426/305; 426/304

(57) ABSTRACT

A food product and method including a portion of cheese configured in an individual, elongated multi-dimensional shape. A batter and bread coating is uniformly encasing the portion of cheese. The coating is composed of a plurality of ingredients suitable for heating without a cheese blowout and comprising a range of 40% to 62.5%, by weight, of the food product. The multi-dimensional shape may define a scoop along the longitudinal length of the portion of cheese.

### BACKGROUND OF THE INVENTION

The present invention relates to food products and more particularly to a bread and batter encrusted portion of food, for example cheese, that is configured in a scoop along its longitudinal length.

It is known in the art to provide filled cheese products and that the filled cheese products can be fried either in a pan fried method or in a deep fried method. It is also known to bread food products, such as cheese, with a batter coating and then par fry and/or freeze the food product.

It is also known that heating, for example, by deep frying, can cause a cheese filling to “blow out” from the batter coating if the food product is fried for longer than three minutes. It is also known that the batter coating typically amounts to 30% or more of the final food product weight in order to prevent a cheese blow out. A cheese blow out, as known in the art, is of the cheese melting within the encrusted batter during the frying process with the cheese flowing out of the encrusted batter into the cooking oil. Such action not only results in an unusable food product but also contaminates the cooking oil.

In order to enhance the market appeal of the food product of the present disclosure, it should also be inexpensive to prepare to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present disclosure.

There is provided a food product including a portion of cheese configured in an individual, elongated, open-cylindrical, multi-dimensional shape. A batter and bread coating is uniformly encasing the portion of cheese. The coating is composed of a plurality of ingredients suitable for heating without a cheese blowout and comprising a range of 40% to 62.5%, by weight, of the food product, wherein the coating is composed of at least two different batters. The multi-dimensional shape defines a scoop.

There is additionally provided a food product including a portion of cheese configured in an individual, elongated, open-cylindrical, multi-dimensional shape. The portion of cheese is encased in a batter and bread coating extending the length of the portion of cheese and composed of at least two different batters and with the coating further composed of a plurality of ingredients suitable for heating without a cheese blowout. The multi-dimensional shape may define a scoop. The coating may further include a natural wheat flour that has been heat treated and a portion of cheese may be mozzarella which may include a food ingredient dispersed in the portion of cheese.

There is also provided a method of making a food product. The method includes providing a quantity of cheese and grinding the cheese. The ground cheese is extruded to create an elongated substrate. The elongated substrate is shaped into an individual, elongated multi-dimensional shape that further includes a scoop. In one embodiment the scoop is along the longitudinal length of the quantity of cheese. A uniform coating is applied to the multi-dimensional shape and the coated scoop shape is pan fried. The coated layered shape is frozen with a quick freeze process and packaged as individual quick frozen coated scoop shaped food products.

In another embodiment the step of applying the coating further includes applying a first batter to the scoop shape, the first batter including an amount of sodium alginate. Applying a first pre-dust to the batter coated scoop shape and applying a second batter to the batter coated scoop shape. The second batter includes an amount of calcium chloride. A second pre-dust is applied to the batter coated scoop shape and a third batter is applied to the batter coated scoop shape. The third batter includes the sodium alginate and finally applying a breading to the batter coated scoop shape.

The food product of the present disclosure is also of inexpensive to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a perspective illustration of an exemplary embodiment of a plurality of servings of batter and bread encrusted cheese scoop food product.

FIG. 2 is a perspective illustration of the food product illustrated in FIG. 1 with a portion of the encrusted coating removed and an interior melted cheese matrix exposed.

FIG. 3 is a top view illustration of an exemplary embodiment of a batter and bread encrusted cheese scoop food product configured in an elongated multi-dimensional shape configured in an open-cylindrical shape defining a C-shape cross-section along the longitudinal length of the product.

FIG. 4 is a cross-section of the batter and bread encrusted cheese scoop food product illustrated in FIG. 3 along the line 4-4.

FIG. 5 is a cross-section of the batter and bread encrusted cheese scoop food product illustrated in FIG. 3 along the longitudinal line 5-5.

FIG. 6 is a schematic block diagram of steps to manufacture a batter and bread encrusted cheese scoop food product.

FIG. 7 is a schematic illustration of an exemplary embodiment of a system for making a batter and bread encrusted cheese scoop food product.

FIG. 8 is a sectional view of an exemplary embodiment of a forming plate of a shaping apparatus aligned with a schematic illustration of an extruder apparatus.

FIG. 9 is a partial front plan view of the forming plate illustrating an exemplary embodiment of an orifice configured to impart a scoop to an extruded cheese substrate.

FIG. 10 is a partial top plan view of the forming plate and orifice illustrated in FIG. 9.

### DETAILED DESCRIPTION OF THE EXEMPLARY EMBODIMENTS

Before describing exemplary embodiments of an encrusted cheese scoop food product several comments are in order. The food service industry typically looks for new, unique cheese appetizers to add to their menu. There are hot dips that are served in a bowl that chips or bread are dipped into and consumed as appetizers, prior to a meal. Typically, cheese appetizers which are fried for a very short time (1 minute, 30 seconds) in the fryer have a fragile coating system. Also, cheese appetizers shaped with sharp corners are difficult to maintain their fry tolerance during the fry process. Further, a cheese appetizer with a multi-dimensional shape is difficult to apply a consistent and uniform coating to the cheese substrate. It is also known in the industry that bite-size cheese encrusted food products are provided however the preparation is different than as described below.

The encrusted cheese scoop food product 10 disclosed herein provides a unique combination of cheese and other ingredients with a battered and breaded coating that serves as the carbohydrate carrier and is the edible device that can be also used as a device to dip into sauce S, especially high particulate sauce, for example salsa or pico de gallo. The preferred cheese is a mozzarella, but other types of cheeses can be used. The food product 10 is configured for deep frying for not longer than two minutes, but the recommended time is between 1 minute to 1 minute 30 seconds, at 350° F. in deep fry oil without a cheese blowout and resulting in a very crunchy, sturdy food product 10.

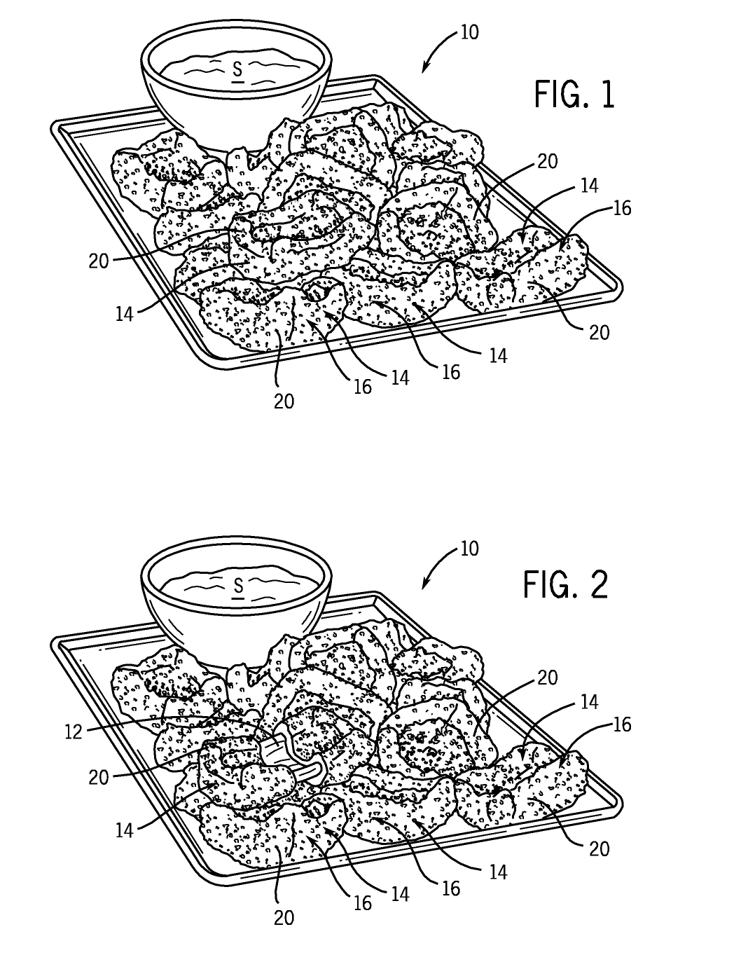

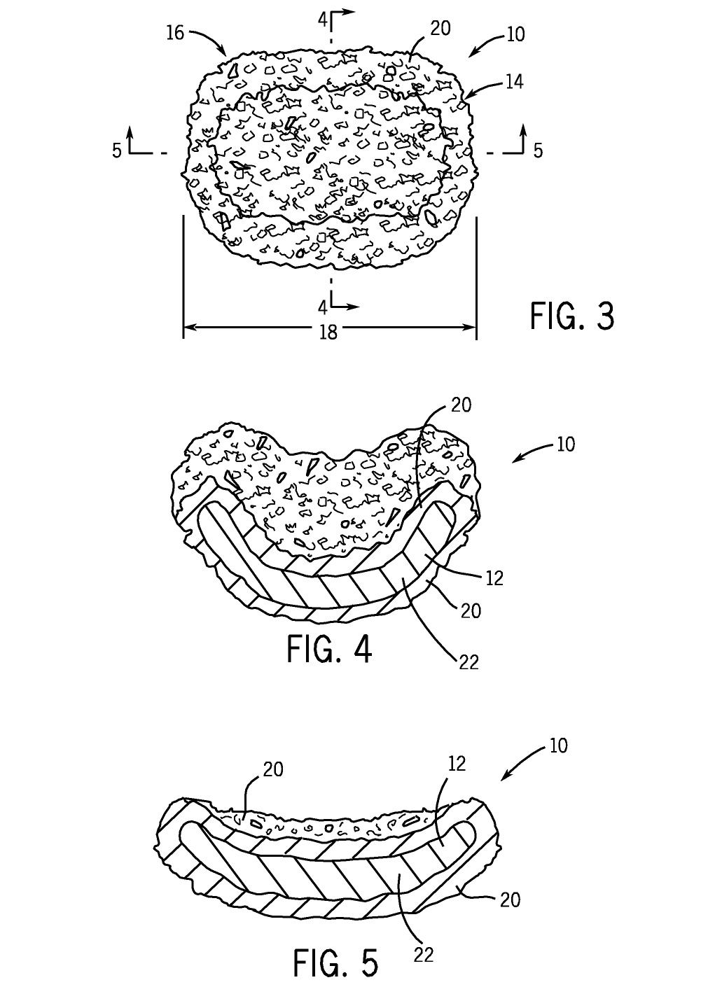

Referring now to the FIGS. 1-10, FIGS. 1 and 3 illustrate a food product 10 in a single serving size 14 and includes a coating 20 encasing a cheese matrix 12 (not visible). Each piece of food product is configured in a scoop shape 16 along the longitudinal length 18 of the food product 10. In cross-section the food product has a U-shape with facing sides curving up defining an open-cylindrical shape. Such scoop shape is also referred to as a C-shape. However, either description describes a convex scoop along a longitudinal length. Each piece of food product includes a coating 20 encasing a portion of cheese 12, which together form an elongated multi-dimensional scoop shape 16.

FIGS. 2, 4, and 5 illustrate the food product 10 illustrated in FIG. 1 with a portion of the coating 20 removed, exposing the cheese matrix 12, also referred to as a portion of cheese, contained in the interior of the single serving size shape 14 food product 10. The portion of cheese 12 is configured in a single serving size wherein the portion of cheese melts at a temperature less than about 110° F. The portion of cheese 12 may include food ingredients for example, parsley, potato, onion, flavors, seasonings, condiments, and stabilizers, or the like, as determined by the manufacturer. The cheese matrix 12 is encased in a batter and bread coating 20 with the coating 20 comprising a range of 40% to 62.5%, by weight, of the final food product 10 with 55% to 62.5% being the usual range. However, a typical coating 20 target weight ratio is 60.5%, by weight, of the final food product 10.

The batter and bread coating 20 includes a plurality of ingredients suitable for heating not longer than two minutes without a cheese blowout or without the coating 20 losing its integrity or shape. One ingredient may be a heat treated natural wheat flour, for example as provided by Siemer Specialty Ingredients. The heat treated wheat flour provides texture and extended frying stability for the food product. Another ingredient may be an amount of wheat gluten. It is found that, if used, a high amount of wheat gluten in the coating 20 provides enhanced texture and extended fryer stability to the coating 20.

The portion of cheese 12 can include a variety of food ingredients which are dispersed in the portion of cheese 12. The food ingredient 22 can be selected from a group consisting of pork, beef, turkey, chicken, fish, vegetable, flavors, seasoning, condiments, stabilizers, and a combination of any two such food ingredients as determined by the manufacturer.

The food product is configured to be heated to cook the coating 20 and melt the cheese matrix 12 encrusted by the coating 20. The preferred method of heating the food product 10 is by deep frying for not longer than two minutes, for example between 1 minute and 1 minute 30 seconds, at 350° F. in frying oil. However it should be understood that the final preparation of the food product 10 can also be accomplished in a conventional, convection, impingement, and speed ovens as determined by the end user. It should be understood that if the end user heating is other than deep frying, as explained above, then during the manufacture of the food product 10 the coated food product is par fried at a par fry station 54 at 400° F. for approximately thirty seconds. The par frying, depending on the portion of cheese 12, may be within the range of 20-45 seconds prior to the freezing step as will be described below.

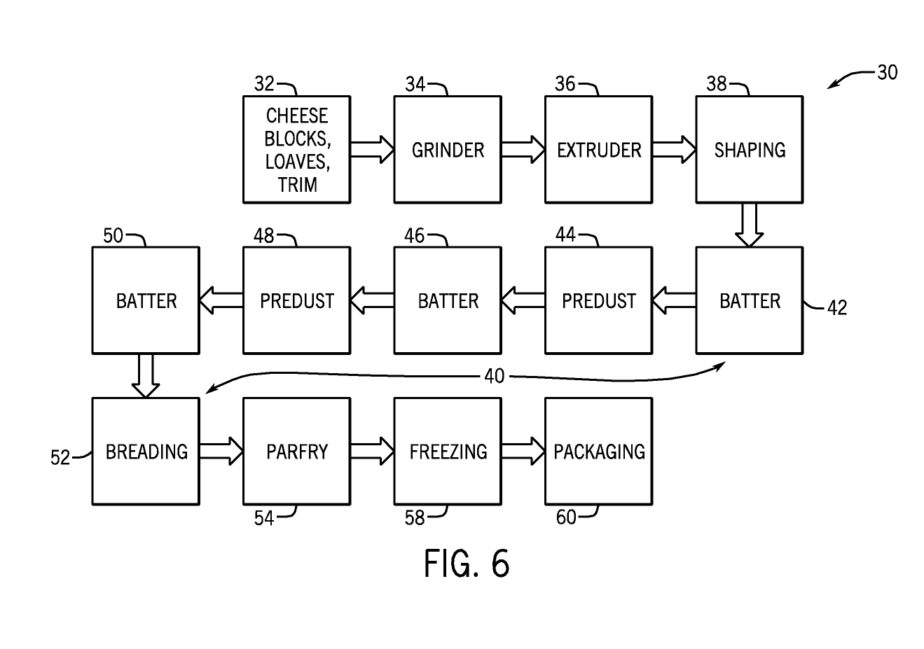

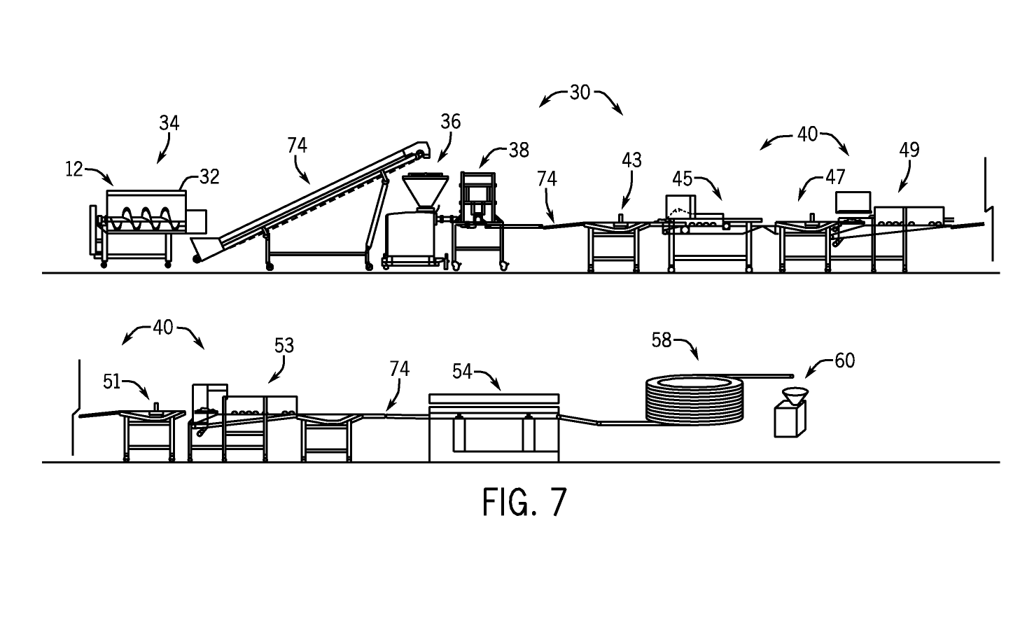

Referring now to FIG. 6, there is illustrated a block diagram of an exemplary method of making a food product 10. A quantity of cheese 12 that can be in the form of blocks, loaves or trim material from other processes is placed in a grinder apparatus 34 as illustrated in FIG. 7. The quantity of cheese 12 is broken up by one of a grinder apparatus 34 and a shredder apparatus which breaks up the cheese pieces into a suitable size, for example, half inch, for extruding. Only the grinder apparatus 34 is illustrated in FIG. 7.

From the grinder apparatus 34, the ground cheese is moved to an extruder apparatus 36 which extrudes the cheese into a portion of cheese 12 and may include food ingredients 22 as determined by the manufacturer. The recipe for extruding the cheese with the food ingredients vary and may include several different types of food ingredients 20 as described above. The extruding and blending of a quantity of cheese with food ingredients 20 creates a concave scoop shape.

The machine settings, for example extrusion speed, discharge angle, and take-away conveyor speed may vary based on the type of cheese, for example cheddar, mozzarella, or colby being used to achieve the unique concave scoop shape. The individual scoop shape pieces of cheese are oriented on the conveyor belt to maintain shape and consistent coating application throughout the process. The extruder apparatus 36 may include a multi-lane extrusion device with a forming plate 70 positioned in front of and aligned with the extrusion device 36.

The shaping apparatus 38 forms the portion of cheese 12 into a concave scoop 16 shape along the longitudinal length 18 of the individual elongated multi-dimensional shape 14. It should be understood that the concave scoop shape can be defined in a line traverse to the longitudinal length if desired by the manufacturer. In such case, the curved opening 71 described below will be modified to produce the desired shape. The shaped cheese portion 12 now is in a form of a concave scoop 16 single serving food product 10. It should be understood that a plurality of individual cheese matrix scoops can be formed with an appropriate amount of the cheese matrix provided to the extruder apparatus 36.

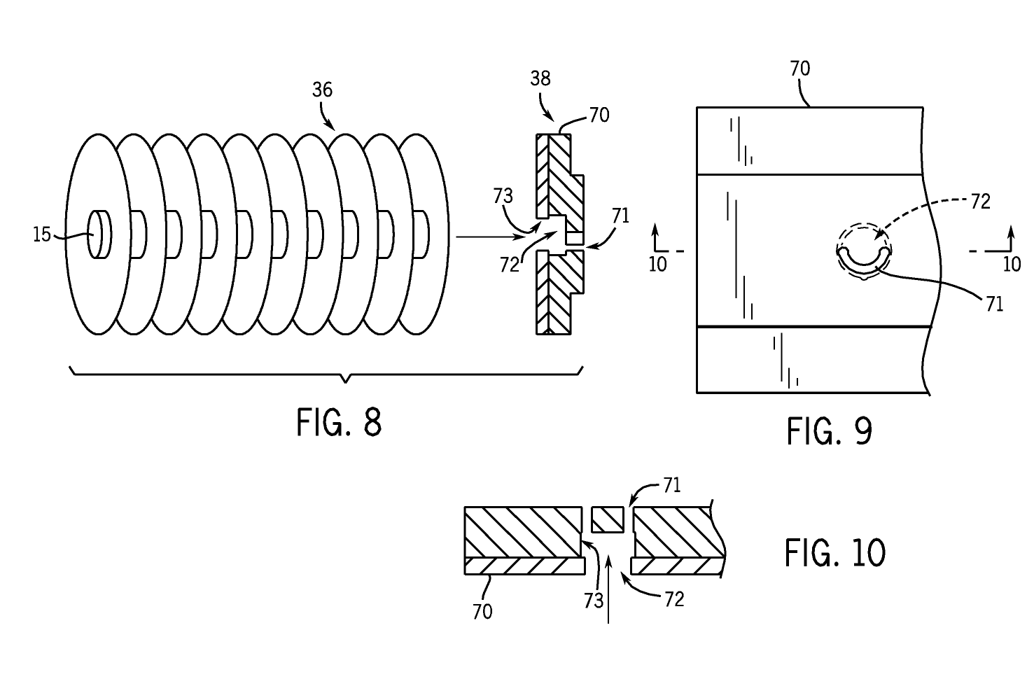

The shaping apparatus 38, see FIG. 7, includes a forming plate 70 (see FIG. 8). The shaping apparatus is aligned with the extruder apparatus 36 so that as cheese substrate 15 exits the extruder apparatus 36, the substrate 15 enters the shaping apparatus 38 and specifically the orifice 72 defined in the forming plate 70.

The ground cheese exits the extruder apparatus 36 and enters the orifice 72. The orifice 72 defines a round opening at the entrance to the shaping apparatus 38. The cheese 15 is forced through the round opening into a pocket 73 defined in the forming plate 70 to allow the cheese to expand. The cheese is then forced through a curved opening 71 defining a U-shape or C-shape concave orifice. Since the curved opening 71 is eccentric towards the bottom of the opening, the cheese flow is greater across the bottom of the curved opening. Such configuration causes the U-shape or C-shape cheese to curl into a scoop shaped piece. Upon exiting the forming plate 70, the elongated, multi-dimensional scoop shape cheese is cut, for example by a wire harp or a blade, to a predetermined length.

It should be understood that a plurality of orifices 72 can be defined in the forming plate 70 to define a plurality of paths for the cheese substrate 15 to produce a plurality of cheese scoop food products. FIGS. 8-10 illustrate only a single orifice for clarity purposes.

The orifice 72 is configured to impart a concave scoop 16 along the longitudinal length 18 of the cheese substrate 15. As the extruder apparatus 36 pushes the cheese substrate 15 into the shaping apparatus 38, the cheese substrate enters one end of the orifice and exits another end. The longitudinal length 18 of the cheese matrix 15 will be determined by the manufacturer. A preferred embodiment will have an approximate length of between 1 and 1.75 inches (2.54 to 4.45 centimeters) overall and an approximate width of 1 to 1.25 inches (2.54 to 3.18 centimeters) overall.

An exemplary embodiment of an orifice 72 is illustrated in FIGS. 8-10. One end of the orifice 72 defines the C-shaped concave orifice 71 leading to a length of cylindrical tube wall with the exit of the orifice 72 at another end diminishing in diameter, wherein as the cheese substrate 15 moves through the length of the orifice, the cylindrical diameter of the cheese substrate 15 remain relatively constant along the longitudinal length 18 with at least one scoop 16 in the length, but preferably a plurality of scoops along the length of the multi-dimensional shape 14 exiting the orifice 72 onto a transfer conveyor section 74 for further processing.

The individual cheese scoop food products 10 are moved to a coating station 40 where the batter and breading steps are implemented. A first batter 42 is applied with a first batter machine 43 to each food portion scoop 12. Movement is typically provided by a suitable metal transfer conveyor 74 or belt conveyor.

The first batter 42 includes an amount of sodium alginate. The sodium alginate typically comprises 0.25 to 5.00% of the batter in a dry batter state. After the first batter 42 is applied, a first predust 44 is applied with a first breading machine 45 to the batter coated scoop. The first predust 44 typically is composed of fine cracker crumbs sifted over the batter coated scoop. The second batter 46 is applied with a second batter machine 47 to the breaded scoop with the second batter 46 including an amount of calcium chloride. The calcium chloride typically comprises 0.25 to 5.00% of the batter in a dry batter state.

Following the second batter 46 application, a second predust 48 is sifted by a second breading machine 49 over the batter coated scoop food product 10. The second predust 48 is similar to the first predust 44. A third batter 50 is then applied with a third batter machine 51 to each food product 10.

It should be understood that the first batter 42 and the third batter 50 are composed of the same recipe even though they are applied at different times at the coating station 40. If heat treated wheat flour is used the amount of heat treated wheat flour that is in the batters can vary between 0.5 to 10% (by weight) of the finished food product 10 but more usually between the range of 1 and 5% by weight, but preferably the batter contains 1.8%, by weight, of the heat treated wheat flour. The batter may also include an amount of wheat gluten as determined by the manufacturer. The final step at the coating station 40 is the application of a breading mix 52 by a third breading machine 53 on the batter coated food product 10 completing the coating 20 composition.

In one exemplary embodiment of the food product 10, the first batter 42 and the third batter 50 are the same. The batters 42, 50 are composed of milk, milk products, wheat and related grains, egg and egg products, salt, sodium alginate and other seasonings , stabilizer, and flavorings. The second batter 46 differs from the other two and is composed of bleached wheat flour, dried whole egg, salt, soybean oil, spice extract, calcium chloride and other seasonings, stabilizer, and flavorings. The first predust 44 is composed of baked fine cracker crumbs, for example, a mixture of bleached wheat flour, salt, soybean oil, and may include assorted flavorings and seasonings. The second predust 48 is composed of a baked bread crumbs, including blended wheat flour, sugar, yeast, soybean oil and salt. Then a predust is applied in the first breading machine 45 and the second breading 49 respectively. The breading 52, is applied by the third breading machine 53, and is composed of wheat flour, and 2% or less of each of the following: sugar, partially hydrogenated soybean oil with TBHQ, salt, yeast and calcium propionate.

In some embodiments an Italian seasoning can be included in the breading. The Italian seasoning can include a mixture of oregano, basil, marjoram, and thyme. It should be understood that various other ingredients, for example, starches, gums, and leavening systems and in different proportions can be used as determined by the manufacturer.

As illustrated in FIG. 7, the three batter machines 43, 47, and 51 include a conveyor well that comprises the coating station 40 allows the food products 10 which are positioned on the conveyor to be dipped in the respective batter machine for coating the cheese substrate 15 with the respective batter. The breading machines 45, 49, and 53 apply the predust and breading by moving the cheese substrate 15 through a curtain of the respective coatings. An air knife apparatus may also be positioned after each of the breading machines to blow off excess predust and breading as necessary.

It should be understood that several transport conveyors 74 are used to convey the cheese substrates 15 and food product 10 between the various processing stations. It is also contemplated that the entire manufacturing process 30 may be configured in a single continuous structural matrix.

After the cheese scoop food product 10 is coated at the coating station 40 each of the food products are par fried at a par frying station 54. In the par frying station 54 the coated food product 10 is immersed in a 400° F. fry oil for approximately 30 seconds. However it should be understood that depending on the composition of the cheese matrix the par frying time may vary between 20 and 45 seconds as determined by the manufacturer. The par fried coated food product 10 is moved to a quick freeze process station 58 producing an individual quick frozen (IQF) food product 10. The individual IQF par fried coated food product 10 is then packaged at a packing station and maintained in the frozen state until appropriate heating by an end user. Such par frying is done to facilitate the heating of the food product 10 by an end user by a process other than deep frying, for example in a conventional oven.

As discussed above, at the coating station 40 the individual cheese scoop is coated in the batter, predust, batter, predust, batter, and breading process with the total coating 20 being in a range of 40% to 62.5% by weight of the final food product 10, but the typical target percentage is 60.5% by weight of coating 20. Also, the portion of cheese 12 that is used in the cheese matrix melts at a temperature less than about 110° F.

Although the foregoing description of the present disclosure has been shown and described with reference to particular embodiments and applications thereof, it has been presented for purposes of illustration and description and is not intended to be exhaustive or to limit the food product and method to the particular embodiments and applications disclosed. It will be apparent to those having ordinary skill in the art that a number of changes, modifications, variations, or alterations to the disclosure as described herein may be made, none of which depart from the spirit or scope of the present disclosure. The particular embodiments and applications were chosen and described to provide the best illustration of the principles of the method and food product and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A food product comprising:
a portion of cheese configured in an individual, elongated, open-cylindrical, multi-dimensional shape; and
a batter and bread coating uniformly encasing the portion of cheese, with the coating composed of a plurality of ingredients suitable for heating without a cheese blowout and comprising a range of 40% to 62.5%, by weight, of the food product, wherein the coating is composed of at least two different batters and wherein the multi-dimensional shape defines a scoop.

2. The food product of claim 1, wherein the multi-dimensional shape defines a scoop along the longitudinal length of the portion of cheese.

3. The food product of claim 1, wherein heating includes par frying.

4. The food product of claim 1, wherein the batter and bread coating comprising at least 55% by weight of the food product.

5. The food product of claim 1, wherein the batter and bread coating comprises a target weight ration of 60.5%, by weight, of the food product.

6. The food product of claim 1, wherein the coating further includes a natural wheat flour which has been heat treated.

7. The food product of claim 1, wherein the coating further includes an amount of wheat gluten.

8. The food product of claim 1, wherein the portion of cheese is a mozzarella.

9. The food product of claim 1, further comprising a food ingredient dispersed in the portion of cheese.

10. The food product of claim 9, wherein the food ingredient is from a group consisting of beef, pork, chicken, turkey, vegetable, flavors, seasoning, condiments, stabilizers, and a combination of any two such food ingredients.

11. A food product comprising:
a portion of cheese configured in an individual, elongated, open-cylindrical, multi-dimensional shape; and
a batter and bread coating composed of at least two different batters uniformly extending the length of and encasing the portion of cheese, with the coating further composed of a plurality of ingredients suitable for heating without a cheese blowout.

12. The food product of claim 11, wherein the multi-dimensional shape defines a scoop.

13. The food product of claim 11, wherein the multi-dimensional shape defines a scoop along the longitudinal length of the portion of cheese.

14. The food product of claim 11, wherein heating includes deep frying.

15. The food product of claim 11, wherein the batter and bread coating comprises a range of 40% to 62.5%, by weight, of the food product.

16. The food product of claim 11, wherein the batter and bread coating comprises a target weight ratio of 60.5%, by weight, of the food product.

17. The food product of claim 11, wherein the coating comprises at least 55%, by weight, of the food product.

18. The food product of claim 11, wherein the coating further includes a natural wheat flour which has been heat treated.

19. The food product of claim 11, wherein the coating further includes an amount of wheat gluten.

20. The food product of claim 11, wherein the portion of cheese is a mozzarella.

21. The food product of claim 11, further comprising a food ingredient dispersed in the portion of cheese.

22. The food product of claim 21, wherein the food ingredient is from a group consisting of beef, pork, chicken, turkey, vegetable, flavors, seasoning, condiments, stabilizers, and a combination of any two such food ingredients.

23. A method of making a food product comprising:
providing a quantity of cheese;
grinding the cheese;
extruding the ground cheese to create an elongated substrate;
shaping the elongated substrate into an individual, elongated multi-dimensional shape and further comprising forming a scoop;
applying a uniform coating to the multi-dimensional shape;
par frying the coated scoop shape;
freezing the layered coated scoop shape with a quick freeze process; and
packaging the individual quick frozen coated shaped food product.

24. The method of making a food product of claim 23, the step of applying the coating further comprising:
applying a first batter to the scoop shape, the first batter including an amount of sodium alginate;
applying a first predust to the batter coated scoop shape;
applying a second batter to the batter coated scoop shape, the second batter including calcium chloride;
applying a second predust to the batter coated scoop shape;
applying a third batter to the batter coated scoop shape, the third batter including sodium alginate; and
applying a breading to the batter coated scoop shape.

25. The food product of claim 23, wherein the multi-dimensional shape defines a scoop along the longitudinal length of the portion of cheese.

26. The method of making a food product of claim 23, further comprising steps of providing food ingredients and mixing the food ingredients with the ground cheese.

27. The method of making a food product of claim 26, wherein the ingredients are selected from a group consisting of processed cheese, meat, fish, vegetables, flavors, seasoning, condiments, stabilizers, and a combination of any two such ingredients.

28. The method of making a food product of claim 23, wherein the coating comprises a range of 40% to 62.5%, by weight, of the food product.

29. The method of making a food product of claim 23, wherein the coating comprises at least 55%, by weight, of the food product.

30. The method of making a food product of claim 23, wherein the coating comprises a target weight ratio of 60.5%, by weight, of the food product.

31. The method of making a food product of claim 23, wherein the portion of cheese is a mozzarella.

32. The method of making a food product of claim 23, wherein the coating includes natural heat treated wheat flour.

33. The method of making a food product of claim 23 wherein the coating includes an amount of wheat gluten.
